(19) United States
(12) Patent Application Publication
(10) Pub. No.: US 2021/0244048 A1
(43) Pub. Date: Aug. 12, 2021

(54) FEED ADDITIVE AND APPLICATION THEREOF

(71) Applicants: HANGZHOU LONGYU BIO-TECHNOLOGY CO., LTD., HANGZHOU (CN); HANGZHOU KANGYUAN FOOD TECHNOLOGY CO., LTD., HANGZHOU (CN); ZHEJIANG UNIVERSITY, HANGZHOU (CN)

(72) Inventors: Fengqin FENG, HANGZHOU (CN); Tao LIU, HANGZHOU (CN)

(73) Assignees: HANGZHOU LONGYU BIO-TECHNOLOGY CO., LTD., HANGZHOU (CN); HANGZHOU KANGYUAN FOOD TECHNOLOGY CO., LTD., HANGZHOU (CN); ZHEJIANG UNIVERSITY, HANGZHOU (CN)

(21) Appl. No.: 17/173,060

(22) Filed: Feb. 10, 2021

(30) Foreign Application Priority Data
Feb. 11, 2020 (CN) 202010087095.0

(51) Int. Cl. A23K 20/105; A23K 50/80; A23K 50/75; A23K 10/30; A23K 50/30; A23K 50/10

(52) U.S. Cl. CPC A23K 20/105; A23K 50/80; A23K 50/10; A23K 10/30; A23K 50/30; A23K 50/75

(57) ABSTRACT

The present disclosure discloses a feed additive and application thereof. The feed additive contains glycerol monolaurate and glycerol monodecanoate. The feed additive is added to the livestock and poultry or aquatic animal feed in different forms, to feed the animals in a feeding manner. Using the feed additive containing glycerol monolaurate and glycerol monodecanoate in the present disclosure in breeding animals such as livestock and poultry or aquatic animals can improve corresponding performances, for example, it can notably improve the production performance of the livestock and poultry or aquatic animals, decreased the feed conversion ratio and mortality, improve the nutritional quality and flavor of meat, eggs and so on.

### CROSS-REFERENCE TO RELATED APPLICATION

This application claims priority to Chinese Patent Application No. 2020100870950, filed with the Chinese Patent Office on Feb. 11, 2020, entitled “Feed Additive and Application thereof”, which is incorporated herein by reference in its entirety.

### TECHNICAL FIELD

The present disclosure relates to the field of livestock and poultry and aquatic animal breeding, in particular, to application of a multifunctional feed additive in improving the production performance of livestock and poultry and aquatic animals, feed utilization rate, and meat and egg quality.

### BACKGROUND ART

Medium-chain fatty acids (MCFAs) are a group of saturated fatty acids with 8˜12 carbon atoms, including octanoic acid (C8:0), capric acid (C10:0) and lauric acid (C12:0), which naturally exist in the milk fat of animals, and coconut oil and palm kernel oil, and are fatty acids rich in nature, easily available and readily utilizable. Medium-chain fatty acid monoglycerides have special chemical and physical properties, which have lower melting points and are more soluble than long-chain fatty acid. They can be transported into the liver directly via the portal vein, then they could be rapidly metabolized and provide energy for extrahepatic organs in the animal body. In addition, medium-chain fatty acid monoglycerides also have high efficiency, broad spectrum bacteriostatic property and antiviral function. In recent years, glycerol monolaurate, as a representative of medium-chain fatty acid monoglycerides, has been widely applied to livestock and poultry and aquatic animal breeding due to its functional properties, wherein the animals cultivated include laying hens (application publication number CN105901390B), fattening pigs (application publication number CN106901007A), soft-shelled turtles (application publication number CN108157614A), weaned pigs (application publication number CN105410365 A), etc. It was found that they exert a significant beneficial effect on the production performance, health and eating quality of farmed animals.

Currently, the application of glycerol monodecanoate in farmed animals such as livestock and poultry and aquatic animals is rarely reported at home and abroad. It has been found in research that, although various medium-chain fatty acid monoglycerides have a stronger bacteriostatic property, their bacteriostatic spectra are not the same, and whether they have a synergistic effect in animal breeding is unclear yet.

### SUMMARY

The present disclosure provides a feed additive containing glycerol monolaurate and glycerol monodecanoate.

The present disclosure further provides a feed for livestock and poultry or aquatic animal, containing the feed additive.

### BRIEF DESCRIPTION OF DRAWINGS

FIG. 1 shows photographs of Longissimus dorsi of swines in a control group (DB1-6) and an experimental group (SB1-6) in Example 6.

### DETAILED DESCRIPTION OF EMBODIMENTS

The technical solutions in the examples of the present disclosure will be described clearly and completely below in conjunction with the drawing in examples of the present disclosure, and apparently, some but not all examples of the present disclosure are described. All of other examples obtained by those ordinarily skilled in the art based on the examples of the present disclosure without using any creative efforts shall fall within the scope of protection of the present disclosure.

Unless otherwise defined herein, scientific and technical terms used herein have the same meanings as that are commonly understood by those skilled in the art of the present disclosure. Terms used herein in the description of the present disclosure are only for the purpose of describing the specific examples, rather than limiting the present disclosure.

The present disclosure provides a feed additive containing glycerol monolaurate and glycerol monodecanoate, and application of the feed additive in improving corresponding properties of farmed animals such as livestock and poultry and aquatic animals, which can notably improve the production performance of livestock and poultry or aquatic animals, decrease the feed conversion ratio and mortality, and notably improve the nutritional quality and flavor of meat, poultry, eggs, etc.

The feed additive includes glycerol monolaurate and glycerol monodecanoate.

The feed additive of the present disclosure contains two kinds of medium-chain fatty acid monoglyceride, and has significant synergistic effect in improving the production performance of farmed animals such as livestock and poultry and aquatic animals, decreasing the feed conversion ratio, promoting health and improving the quality of meat and egg, and has the advantages such as a low addition amount, significant effect, high safety, and green and health.

Optionally, the mass ratio of the glycerol monolaurate to the glycerol monodecanoate is 0.11˜9:1.

Optionally, the mass ratio of the glycerol monolaurate to the glycerol monodecanoate is 0.25˜4:1.

Optionally, the mass ratio of the glycerol monolaurate to the glycerol monodecanoate is 0.43˜2.43:1.

Optionally, the mass ratio of the glycerol monolaurate to the glycerol monodecanoate is 0.67˜1.5:1.

Optionally, the mass ratio of the glycerol monolaurate to the glycerol monodecanoate is 1:1.

Optionally, the addition amount of the feed additive to an animal feed is 0.1˜2.0‰ of the total mass of the animal feed.

Optionally, an inert carrier is further contained, and the glycerol monolaurate and/or the glycerol monodecanoate is deposited on the inert carrier.

Optionally, the carrier may be selected from conventional carriers in the field of feed such as silica, zeolite powder, maltodextrin, and starch.

The present disclosure further provides a feed for livestock and poultry or aquatic animal, containing the feed additive.

Optionally, the addition amount of the feed additive to the animal feed is 0.1˜2.0‰ of the total mass of the animal feed, that is, the total mass of the glycerol monolaurate and the glycerol monodecanoate is 0.1˜2.0‰ of the total mass of the animal feed.

Further, the addition amount of the feed additive to the animal feed is 0.1˜1.0‰ of the total mass of the animal feed, that is, the total mass of the glycerol monolaurate and the glycerol monodecanoate is 0.1˜1.0‰ of the total mass of the animal feed.

Generally, the animal feed includes a basal diet and the feed additive, and the basal feed refers to a conventional or commercially available animal feed, or is prepared according to a conventional formulation.

A method of using the feed additive is as follows: adding the feed additive directly to a complete formula feed to feed livestock and poultry or aquatic animals, or adding the feed additive directly to a premix feed or concentrated feed, and then preparing the premix feed or concentrated feed with other feed raw materials into a complete formula feed to feed the livestock and poultry or aquatic animals; or mixing the feed additive with a carrier to prepare a premix agent, and then directly adding the premix agent to a complete formula feed to feed the livestock and poultry or aquatic animals; or adding the additive to the premix feed or concentrated feed, and then preparing the premix feed or concentrated feed and other raw materials into a complete formula feed to feed livestock and poultry or aquatic animals.

The livestock and poultry or aquatic animals include, but are not limited to, broilers, laying hens, weaned pigs, fattening pigs, carps, grass carps, dairy cows, beef cattle and so on, and according to different types of animals fed during practical application, different complete formula feeds or other feed raw materials used for formulating the complete formula feeds may be selected correspondingly. The complete formula feeds or other feed raw materials used for formulating the complete formula feeds are conventional formulations in the prior art, and are not described herein again.

In the method of using the feed additive, in addition to preparing the feed additive into the form of premix agent, premix feed or concentrated feed, it may also be added directly to the animal feed to feed animals, for example, the feed additive is homogeneously mixed with basal diet of animal feed and used to feed animals, all of which can improve the production performance of livestock and poultry or aquatic animals, feed utilization rate and survival rate by being taken into the body of animals, and notably improve the nutritional quality and flavor of animal food such as meat and eggs.

It is worth noting that, whether the feed additive is prepared into the form of premix feed, premix agent or concentrated feed, or the feed additive is directly added to the basal diet of animal feed, the feed additive is added in a manner of feeding through the feed.

The present disclosure further provides application of the feed additive for a broiler feed so as to improve production performance, meat yield and quality of broilers.

The production performance described herein may refer to broilers' average body weight, relative growth yield, feed conversion ratio, etc.; the meat yield may refer to leg muscle yield and breast muscle yield of the broilers and the like; and the meat quality may refer to contents of total muscle amino acids and muscle flavor amino acids and sensory quality of chicken, wherein the sensory quality includes, but is not limited to, overall sensation, chicken taste, chicken broth taste, etc.

In the application of broiler feed, composite medium-chain fatty acid monoglyceride composed of glycerol monolaurate and glycerol monodecanoate can synergistically improve the production performance and chicken quality of broilers, including notably increasing the average slaughtering weight, and notably increasing the feed intake and daily weight gain, decreasing mortality, decreasing feed conversion ratio, and increasing dressing percentage, eviscerated yield, breast muscle yield and leg muscle yield of broilers, meanwhile, the drip loss and the pH change of the chicken breast further may be notably reduced, and the contents of total muscle fatty acids, total muscle amino acids and muscle flavor amino acids and muscle sweet amino acids are notably increased.

An implementation method of the application may be as follows: mixing the feed additive into a premix feed, and then adding the resultant to a basalfeed to be mixed, and alternatively, the feed additive may be directly mixed with other raw materials of a basal feed diet after compounding.

As a conventional feed of broiler, the basal feed of broiler is commercially available. In one embodiment, the basal feed during the starter phase adopts the following formulation: corn 56.90%, soybean meal 33.00%, fish meal 3.00%, stone powder 1.20%, calcium hydrogen phosphate 1.45%, methionine 0.15%, salt 0.30%, and premix feed 1.00% in mass percentage. The nutritional ingredients of the feed raw materials are: crude protein 20.98%, lysine 1.17%, methionine 0.48%, cysteine 0.40%, total calcium 1.08%, non-phytate phosphorus 0.45%, and total phosphorus 0.68%.

The basal feed during the finisher phase adopts the following formulation: corn 59.66%, soybean meal 32.20%, stone powder 1.15%, calcium hydrogen phosphate 1.65%, methionine 0.14%, salt 0.30%, and a commercial premix feed 1.00% in mass percentage. The nutritional ingredients of the feed raw materials are: crude protein 18.83%, lysine 1.00%, methionine 0.42%, cysteine 0.30%, total calcium 0.88%, non-phytate phosphorus 0.40%, and total phosphorus 0.66%.

In the above, the nutritional ingredients of the premix feed are: vitamin A (12,500 IU), vitamin D₃ (2500 IU), vitamin E (20 IU), vitamin B1 (4 mg), vitamin B2 (6 mg), vitamin B6 (5 mg), vitamin B12 (0.5 mg), vitamin K3 (5 mg), biotin (0.2 mg), folate (1.5 mg), pantothenic acid (15 mg), nicotinic acid (30 mg), copper (10 mg), iron (100 mg), manganese (100 mg), zinc (100 mg), iodine (100 mg), and selenium (0.2 mg) in 1 kg of the premix feed.

Optionally, the addition amount of the feed additive to the livestock and poultry or aquatic animal feed is 0.1˜2.0‰ of the total mass of the livestock and poultry or aquatic animal feed, that is, the total mass of the glycerol monolaurate and the glycerol monodecanoate is 0.1˜2.0‰ of the total mass of the livestock and poultry or aquatic animal feed.

The feed additive is added in proportions to the basal feed in the brooding period and the basal feed in the finisher phase, respectively, that is, the brooding period feed includes the basal feed and the feed additive, the feed additive occupies 0.1-2.0‰ of the total mass, the finisher phase feed includes the basal feed and the feed additive, and the feed additive occupies 0.1-2.0‰ of the total mass.

Further optionally, the addition amount of the feed additive to the broiler feed is 0.1˜1.0‰ of the total mass of the broiler feed, that is, the total mass of the glycerol monolaurate and the glycerol monodecanoate is 0.1˜1.0‰ of the total mass of the broiler feed.

Optionally, the mass ratio of the glycerol monolaurate to the glycerol monodecanoate in the feed additive is 0.11˜9:1.

Optionally, the addition amount of the feed additive to the broiler feed is 0.3-0.8‰ of the total mass of the broiler feed, that is, the total mass of the glycerol monolaurate and the glycerol monodecanoate is 0.3-0.8‰ of the total mass of the broiler feed; and the mass ratio of the glycerol monolaurate to the glycerol monodecanoate in the feed additive is 1˜3:1.

Further, the addition amount of the feed additive to the broiler feed is 0.3-0.6‰ of the total mass of the broiler feed, that is, the total mass of the glycerol monolaurate and the glycerol monodecanoate is 0.3-0.6‰ of the total mass of the broiler feed; and the mass ratio of the glycerol monolaurate to the glycerol monodecanoate in the feed additive is 2˜3:1.

Further, the addition amount of the feed additive to the broiler feed is 0.3-0.6‰ of the total mass of the broiler feed, that is, the total mass of the glycerol monolaurate and the glycerol monodecanoate is mass 0.3-0.6‰ of the total mass of the broiler feed; and the mass ratio of the glycerol monolaurate to the glycerol monodecanoate in the feed additive is 2:1.

The present disclosure further provides application of the feed additive for a laying hen feed so as to improve egg production performance of laying hens, feed utilization rate and egg quality.

The egg production performance may refer to laying yield, average egg weight, etc.; and the egg quality may refer to albumen height, Haugh unit, egg shell strength, egg shell thickness of the eggs, and the like.

In the application of the laying hen feed, the composite medium-chain fatty acid monoglyceride composed of the glycerol monolaurate and the glycerol monodecanoate can synergistically improve the egg production performance and egg quality of laying hens, including notably improving the laying yield, increasing the average egg weight, notably reducing the feed conversion ratio, and meanwhile notably increasing the albumen height, Haugh unit, egg shell strength, and egg shell thickness of the eggs.

An implementation method of the application may be as follows: mixing the feed additive into the premix feed, and then adding the resultant to the basal feed to be mixed, and alternatively, the feed additive may be directly mixed with other raw materials of the basal feed after compounding.

The basal feed of laying hens may adopt a conventional laying hen feeding feed, and is commercially available or prepared according to the conventional formulation. In one embodiment, the basal feed of laying hens is a conventional laying hen feeding feed, and the basal feed of laying hens adopts the following formulation: corn 62.90%, soybean meal 23.55%, stone powder 7.93%, salt 0.30%, fish oil 0.03%, rapeseed oil 0.59%, and a premix feed 4.70% in mass percentage. The nutritional ingredients of the feed raw materials are: crude protein 16.10%, crude fat 2.86%, total calcium 3.73%, total phosphorus 0.60%, lysine 0.81%, and methionine+cysteine 0.65%.

In the above, the nutritional ingredients of the premix feed are: vitamin A (10,000 IU), vitamin E (200 IU), vitamin B1 (4 mg), vitamin B2 (6 mg), vitamin B6 (5 mg), vitamin B12 (1 mg), vitamin K3 (3 mg), biotin (0.5 mg), folate (3 mg), pantothenic acid (20 mg), nicotinic acid (20 mg), copper (10 mg), iron (100 mg), manganese (100 mg), zinc (100 mg), and selenium (0.4 mg) in 1 kg of the premix feed.

Optionally, the addition amount of the feed additive to the laying hen feed is 0.1˜1.0‰ of the total mass of the laying hen feed.

Optionally, the mass ratio of the glycerol monolaurate to the glycerol monodecanoate in the feed additive is 0.11˜9:1.

Optionally, the addition amount of the feed additive to the laying hen feed is 0.3-0.8‰ of the total mass of the laying hen feed, that is, the total mass of the glycerol monolaurate and the glycerol monodecanoate is 0.3-0.8‰ of the total mass of the laying hen feed; and the mass ratio of the glycerol monolaurate to the glycerol monodecanoate in the feed additive is 1˜9:1.

Further, the addition amount of the feed additive to the laying hen feed is 0.3‰ of the total mass of the laying hen feed, that is, the total mass of the glycerol monolaurate and the glycerol monodecanoate is 0.3‰ of the total mass of the broiler feed; and the mass ratio of the glycerol monolaurate to the glycerol monodecanoate in the feed additive is 1˜9:1.

When the two are compounded at 9:1, the laying yield of the laying hens can be increased to a maximum extent, while when the two are compounded at 1:1, the feed conversion ratio can be decreased to a maximum extent, and the weight of individual eggs can be notably increased, thus increasing the production.

Still further, the addition amount of the feed additive to the laying hen feed is 0.3‰ of the total mass of the laying hen feed, that is, the total mass of the glycerol monolaurate and the glycerol monodecanoate is 0.3‰ of the total mass of the broiler feed; and the mass ratio of the glycerol monolaurate to the glycerol monodecanoate in the feed additive is 9:1.

The present disclosure further provides application of the feed additive for a pig feed so as to improve growth performance of swines, feed utilization rate and pork quality.

The growth performance of swines may refer to average weight, total weight gain, average daily weight gain and absolute growth yield of weaned pigs; and the pork quality may refer to intermuscular fat content and protein content of pork, and may also refer to serum health indicator, for example, contents of total proteins, blood glucose, and blood calcium and the like in serum.

In the application of the pig feed, the composite medium-chain fatty acid monoglyceride composed of the glycerol monolaurate and the glycerol monodecanoate can synergistically improve the growth performance and pork quality of pigs, including notably increasing average slaughtering weight of fattening pigs, notably increasing total weight gain, average daily weight gain and the degree of uniformity of fattening pigs, and notably reducing the feed conversion ratio and mortality, and meanwhile also increasing the dressing percentage of pigs, increasing the contents of intermuscular fat and protein of pork, reducing the fat taste, adding the flavor and improving the mouthfeel; it is also possible to notably increase the total weight gain and average daily weight gain of weaned pigs, decrease the mortality, increase the absorption and utilization of calcium, protein and carbohydrate by weaned pigs, and at the same time promote the health of swine.

One implementation method of the application may be as follows: mixing the feed additive into the premix feed, and then adding the resultant to the basal feed to be mixed, and alternatively, the feed additive may be directly mixed with other raw materials of the basal feed after compounding.

The basal feed of pigs may adopt a conventional feeding feed of pigs, and is commercially available or prepared according to the conventional formulation. In one embodiment, the basal feed of weaned pigs adopts the following formulation: corn 57%, soybean meal 25%, wheat meal 10.0%, fish meal 2.0%, soybean oil 2.0%, and a premix feed 4.0% in mass percentage. The nutritional ingredients of the feed raw materials are: crude protein 19.3%, lysine 1.26%, total calcium 0.68%, and total phosphorus 0.57%.

The basal feed of the fattening pigs adopts the following formulation: corn 72.0%, soybean meal 20.0%, wheat meal 4.0%, stone powder 1.1%, calcium bicarbonate 1.4%, salt 0.3%, lysine 0.2%, and a premix feed 1.0% in mass percentage. The nutritional ingredients of the feed raw materials are: crude protein 15.81%, lysine 0.98%, total calcium 0.88%, and total phosphorus 0.57%.

In the above, the nutritional ingredients of the premix feed are: vitamin A (15,500 IU), vitamin D₃ (3000 IU), vitamin E (100 IU), vitamin B1 (3 mg), vitamin B2 (8 mg), vitamin B6 (5 mg), vitamin B₁₂ (0.04 mg), vitamin K3 (3 mg), vitamin C (160 mg), biotin (0.3 mg), folate (2.0 mg), pantothenic acid (20 mg), nicotinic acid (45 mg), copper (230 mg), iron (180 mg), manganese (50 mg), zinc (180 mg), iodine (0.5 mg), and selenium (0.2 mg) in 1 kg of the premix feed.

Optionally, the addition amount of the feed additive to the pig feed is 0.1˜1.0‰ of the total mass of the pig feed in mass percentage.

The feed additive is added to the basal feed of weaned pigs and the basal feed of fattening pigs respectively, i.e. in a feeding phase of weaned pigs, the feed additive is added to the basal feed in the phase in an addition amount of 0.1-1.0‰ of the total mass of the feed in the phase, and in a fattening feeding phase, the feed is added to the basal feed in this phase in an addition amount of 0.1˜1.0‰ of the total mass of the feed in this phase.

Optionally, the mass ratio of the glycerol monolaurate to the glycerol monodecanoate in the feed additive is 0.11˜9:1.

Optionally, the addition amount of the feed additive to the pig feed is 0.2-0.8‰ of the total mass of the pig feed, that is, the total mass of the glycerol monolaurate and the glycerol monodecanoate is 0.2-0.8‰ of the total mass of the pig feed; and the mass ratio of the glycerol monolaurate to the glycerol monodecanoate in the feed additive is 1˜9:1.

Further, the addition amount of the feed additive to the pig feed is 0.45‰ of the total mass of the pig feed, that is, the total mass of the glycerol monolaurate and the glycerol monodecanoate is 0.45‰ of the total mass of the pig feed; and the mass ratio of the glycerol monolaurate to the glycerol monodecanoate in the feed additive is 3˜9:1.

The present disclosure further provides application of the feed additive for an aquatic feed so as to improve production performance of aquatic animals, feed utilization rate and meat quality.

The production performance of aquatic animals may refer to average weight, total weight gain and the like of the aquatic animals.

In the application of the aqueous feed, the composite medium-chain fatty acid monoglyceride composed of the glycerol monolaurate and the glycerol monodecanoate can synergistically improve the production performance of aquatic animals and feed utilization rate, including notably increasing average body weight and total weight gain of carps, notably reducing bait coefficient; notably increasing average body weight and total weight of grass carps, notably reducing the bait coefficient.

One implementation method of the application may be as follows: mixing the feed additive into the premix feed, and then adding the resultant to the basal feed to be mixed, and alternatively, the feed additive also may be directly mixed with other raw materials of the basal diet after compounding.

Optionally, in mass percentage, the addition amount of the feed additive to the aquatic feed is 0.1˜1.0‰ of the total mass of the aquatic feed, that is, the total mass of the glycerol monolaurate and the glycerol monodecanoate is 0.1˜1.0‰ of the total mass of the aquatic feed.

Optionally, the mass ratio of the glycerol monolaurate to the glycerol monodecanoate in the feed additive is 0.11˜9:1.

Optionally, the aquatic feed is a grass carp feed, the addition amount of the feed additive to the aquatic feed is 0.3‰˜0.8‰ of the total mass of the aquatic feed, that is, the total mass of the glycerol monolaurate and the glycerol monodecanoate is 0.3‰˜0.8‰ of the total mass of the aquatic feed; and the mass ratio of the glycerol monolaurate to the glycerol monodecanoate in the feed additive is 1˜9:1. Under the conditions of the addition amount and the ratio, the production performance of grass carps is notably improved.

Further, the aquatic feed is a grass carp feed, the addition amount of the feed additive to the aquatic feed is 0.45‰˜0.6‰ of the total mass of the aquatic feed, that is, the total mass of the glycerol monolaurate and the glycerol monodecanoate is 0.45‰˜0.6‰ of the total mass of the aquatic feed; and the mass ratio of the glycerol monolaurate to the glycerol monodecanoate in the feed additive is 1˜9:1.

Still further, the aquatic feed is a grass carp feed, the addition amount of the feed additive to the aquatic feed is 0.6‰ of the total mass of the aquatic feed, that is, the total mass of the glycerol monolaurate and the glycerol monodecanoate is 0.6‰ of the total mass of the aquatic feed; and the mass ratio of the glycerol monolaurate to the glycerol monodecanoate in the feed additive is 1˜3:1.

The aquatic feed is a carp feed, the addition amount of the feed additive to the aquatic feed is 0.4‰˜0.8‰ of the total mass of the aquatic feed, that is, the total mass of the glycerol monolaurate and the glycerol monodecanoate is 0.4‰˜0.8‰ of the total mass of the aquatic feed; and the mass ratio of the glycerol monolaurate to the glycerol monodecanoate in the feed additive is 1˜9:1. Under the conditions of the addition amount and the ratio, the production performance of carps and feed utilization rate are notably improved.

Further, the aquatic feed is a carp feed, the addition amount of the feed additive to the aquatic feed is 0.45‰ of the total mass of the aquatic feed, that is, the total mass of the glycerol monolaurate and the glycerol monodecanoate is 0.45‰ of the total mass of the aquatic feed; and the mass ratio of the glycerol monolaurate to the glycerol monodecanoate in the feed additive is 1˜9:1.

The basal feed of the aquatic feed is a conventional aquatic feeding feed, and is commercially available or prepared according to the conventional formulation. In one embodiment, for example, the carp basal feed adopts the following formulation: fish meal 5%, soybean meal 28%, cottonseed meal 8%, rapeseed meal 15%, corn protein meal 8%, bran coat 27%, fish oil 6.5%, calcium dihydrogen phosphate 1.0%, choline chloride 0.5%, and a premix feed 1.0% in mass percentage. The nutritional ingredients of the feed raw materials are: crude protein 38.57%, crude fat 9.75%, crude ash 6.70%, and crude fiber 4.86%.

In the above, the nutritional ingredients of the premix feed are: vitamin A (10,000 IU), vitamin D3 (3000 IU), vitamin E (150 IU), vitamin K3 (3 mg), vitamin B1 (20 mg), vitamin B2 (20 mg), vitamin B3 (100 mg), vitamin B6 (22 mg), vitamin B12 (0.15 mg), vitamin C (500 mg), biotin (0.1 mg), folate (8 mg), and inositol (500 mg) in 1 kg of the premix feed.

The grass carp basal feed adopts the following formulation: soybean meal 18%, cottonseed meal 16%, rapeseed meal 18%, bran coat 10%, defatted rice bran 10%, wheat middling 22.45%, soybean oil 1%, fish meal 2%, calcium dihydrogen phosphate 1.5%, a premix feed 0.55%, and choline chloride 0.5% in mass percentage. The nutritional ingredients of the feed raw materials are: crude protein 32.5%, crude fat 5.6%, crude ash 6.6%, and water 10.5%.

In the above, the nutritional ingredients of the premix feed are: vitamin A (10,000 IU), vitamin D3 (3000 IU), vitamin E (150 IU), vitamin K3 (12.17 mg), vitamin B1 (20 mg), vitamin B2 (20 mg), vitamin B3 (100 mg), vitamin B6 (22 mg), vitamin B12 (0.15 mg), vitamin C (1000 mg), biotin (0.6 mg), folate (8 mg), inositol (500 mg), iodine (1.5 mg), cobalt (0.6 mg), copper (3 mg), iron (63 mg), magnesium (180 mg), manganese (11.45 mg), zinc (89 mg), and selenium (0.24 mg) in 1 kg of the premix feed.

The present disclosure further provides application of the feed additive for a dairy cow feed so as to increase contents of proteins and non-milk fat solids in cow milk.

In the application of the dairy cow feed, the composite medium-chain fatty acid monoglyceride composed of the glycerol monolaurate and the glycerol monodecanoate can synergistically improve the production performance of cows and quality, including greatly increasing the content of milk proteins and the content of non-milk fat solids of milk.

One implementation method of the application may be as follows: mixing the feed additive into the premix feed, and then adding the resultant to the basal feed to be mixed, and alternatively, the feed additive also may be directly mixed with other raw materials of the basal diet after compounding.

The basal feed for dairy cows may be a conventional feeding feed for dairy cows, may be commercially available, and may also be prepared according to a conventional formulation. In one embodiment, the basal diet of the dairy cow adopts the following formulation: alfalfa 24.7%, silage corn 27.6%, corn 24.4%, soybean meal 14.5%, wheat bran 2.0%, cottonseed 4.3%, calcium bicarbonate 0.8%, sodium chloride 0.7% and a premix feed 1% in mass percentage. The nutritional ingredients of the feed raw materials are: crude protein 17.35%, neutral detergent fiber 31.25%, acid detergent fiber 22.63%, and crude ash 7.40 in mass percentage.

In the above, the nutritional ingredients of the premix feed are: vitamin A (15,000 IU), vitamin D3 (3000 IU), vitamin E (400 IU), iodine (1 mg), cobalt (0.5 mg), copper (13 mg), iron (90 mg), manganese (60 mg), zinc (100 mg), and selenium (0.5 mg) in 1 kg of the premix feed.

Optionally, in mass percentage, the addition amount of the feed additive to the dairy cow feed is 0.3‰˜1.5‰ of the total mass of the dairy cow feed, that is, the total mass of the glycerol monolaurate and the glycerol monodecanoate is 0.3‰˜1.5‰ of the total mass of the dairy cow feed.

Optionally, the mass ratio of the glycerol monolaurate to the glycerol monodecanoate in the feed additive is 0.3˜3:1.

Optionally, in mass percentage, the addition amount of the feed additive to the dairy cow feed is 0.5-1.2‰ of the total mass of the dairy cow feed, that is, the total mass of the glycerol monolaurate and the glycerol monodecanoate is 0.5-1.2‰ of the total mass of the dairy cow feed; and the mass ratio of the glycerol monolaurate to the glycerol monodecanoate in the feed additive is 1˜3:1.

Further, the addition amount of the feed additive to the dairy cow feed is 0.6‰ of the total mass of the dairy cow feed, that is, the total mass of the glycerol monolaurate and the glycerol monodecanoate is 0.6‰ of the total mass of the dairy cow feed; and the mass ratio of the glycerol monolaurate to the glycerol monodecanoate in the feed additive is 1:1.

The present disclosure further provides application of the feed additive for a beef cattle feed so as to improve production performance of beef cattle.

The production performance of beef cattle may refer to total weight gain and average daily weight gain of the beef cattle. The beef cattle are yellow cattle, Simmental cattle, and Angus cattle.

In the application of the beef cattle feed, the composite medium-chain fatty acid monoglyceride composed of the glycerol monolaurate and the glycerol monodecanoate can synergistically improve the production performance of the beet cattle.

One implementation method of the application may be as follows: mixing the feed additive into the premix feed, and then adding the resultant to the basal feed to be mixed, and alternatively, the feed additive also may be directly mixed with other raw materials of the basal diet after compounding.

The basal feed may be a conventional feeding feed for beef cattle, may be commercially available, and may also be prepared according to a conventional formulation. In one embodiment, the basal feed adopts the following formulation: silage napiergrass 60%, corn 24.16%, wheat bran 2.62%, soybean meal 11.72%, soda 0.25%, sodium chloride 0.25%, and a premix feed 1% in mass percentage. The nutritional ingredients of the feed raw materials are: crude protein 13.58%, crude fat 2.98%, neutral detergent fiber 47.78%, acid detergent fiber 19.16%, and crude ash 7.40%.

In the above, the nutritional ingredients of the premix feed are: vitamin A (15,000 IU), vitamin D3 (2000 IU), vitamin E (300 IU), iodine (1 mg), cobalt (1 mg), copper (15 mg), iron (100 mg), manganese (80 mg), zinc (150 mg), and selenium (0.5 mg) in 1 kg of the premix feed.

Optionally, the addition amount of the feed additive to the beef cattle feed is 0.3˜1.5‰ of the total mass of the beef cattle feed, that is, the total mass of the glycerol monolaurate and the glycerol monodecanoate is 0.3˜1.5‰ of the total mass of the beef cattle feed.

Optionally, the mass ratio of the glycerol monolaurate to the glycerol monodecanoate in the feed additive is 0.3˜3:1.

Optionally, the addition amount of the feed additive to the beef cattle feed is 0.5˜1.2‰ of the total mass of the beef cattle feed, that is, the total mass of the glycerol monolaurate and the glycerol monodecanoate is 0.5˜1.2‰ of the total mass of the beef cattle feed; and the mass ratio of the glycerol monolaurate to the glycerol monodecanoate in the feed additive is 1˜3:1.

Further, the addition amount of the feed additive to the beef cattle feed is 0.7‰ of the total mass of the beef cattle feed, that is, the total mass of the glycerol monolaurate and the glycerol monodecanoate is 0.7‰ of the total mass of the beef cattle feed; and the mass ratio of the glycerol monolaurate to the glycerol monodecanoate in the feed additive is 1.5:1.

Compared with the prior art, the present disclosure at least has the following beneficial effects.

(1) The combination of the glycerol monodecanoate and the glycerol monolaurate in the feed additive of the present disclosure can synergistically promote the production performance of livestock and poultry and aquatic animals, including increasing the average slaughtering weight, feed intake, daily weight gain and feed utilization rate, improving the economic effectiveness of breeding, and also notably promoting the health of livestock and poultry and aquatic animals, and increasing the survival rate.

(2) The feed additive of the present disclosure may notably increase the dressing percentage of the livestock and poultry, yield of eggs, milk and aquatic animals, improve the appearance quality of livestock and poultry, livestock and poultry products and aquatic products, and also may improve the mouthfeel and flavor after cooking, and may provide sufficient, high-quality food raw materials for people's good life.

(3) The feed additive provided in the present disclosure is a natural, green and safe feed additive, which may notably improve the production performance of livestock and poultry and aquatic animals by composite application, which may directly bring considerable economic benefits to the breeding industry with livestock and poultry and aquatic animals, and meanwhile, the animals will not be rendered resistant to drugs, and the produced products have better quality, and extremely high application value.

In the following examples, the addition amount of the additive, if not specified, refers to the mass ratio of the total amount of the complete feed; the glycerol monolaurate (%) and the glycerol monodecanoate (%) in the table refer to their mass ratios in the additive. The glycerol monolaurate and the glycerol monodecanoate used in the examples below are both commercially available, wherein CAS No. of the glycerol monolaurate is 142-18-7, and CAS No. of the glycerol monodecanoate is 26402-22-2.

### Broiler Examples

The basal feed in the starter phase adopted the following formulation: corn 56.90%, soybean meal 33.00%, fish meal 3.00%, stone powder 1.20%, calcium hydrogen phosphate 1.45%, methionine 0.15%, salt 0.30%, and a premix feed 1.00% in mass percentage. The nutritional ingredients of the feed raw materials were: crude protein 20.98%, lysine 1.17%, methionine 0.48%, cysteine 0.40%, total calcium 1.08%, non-phytate phosphorus 0.45%, and total phosphorus 0.68%.

The basal feed in the finisher phase adopted the following formulation: corn 59.66%, soybean meal 32.20%, stone powder 1.15%, calcium hydrogen phosphate 1.65%, methionine 0.14%, salt 0.30%, and a commercial premix feed 1.00% in mass percentage. The nutritional ingredients of the feed raw materials were: crude protein 18.83%, lysine 1.00%, methionine 0.42%, cysteine 0.30%, total calcium 0.88%, non-phytate phosphorus 0.40%, and total phosphorus 0.66%.

In the above, the nutritional ingredients of the premix feed were: vitamin A (12,500 IU), vitamin D₃ (2500 IU), vitamin E (20 IU), vitamin B1 (4 mg), vitamin B2 (6 mg), vitamin B6 (5 mg), vitamin B12 (0.5 mg), vitamin K3 (5 mg), biotin (0.2 mg), folate (1.5 mg), pantothenic acid (15 mg), nicotinic acid (30 mg), copper (10 mg), iron (100 mg), manganese (100 mg), zinc (100 mg), iodine (100 mg), and selenium (0.2 mg) in 1 kg of the premix feed.

### Example 1

900 1-day old male Lingnan yellow broilers with similar body weight were randomly divided into 6 groups, each group was provided with 6 replicates, and each replicate included 25 chicks. The control group was fed with the basal feed, Experimental Groups 1, 2, 3, 4, and 5 were fed with the basal feed added with the feed additive with a mass fraction of 0.45‰, and the formulations are shown in Table 1: The experimental period was 8 weeks in total.

TABLE 1

| | | | Glycerol |
|---|---|---|---|
| | Addition | Glycerol | monodecanoate |
| Group | Amount (‰) | monolaurate (%) | (%) |
| Control Group | 0 | 0 | 0 |
| Experimental | 0.45 | 100 | 0 |
| Group 1 | | | |
| Experimental | 0.45 | 90 | 10 |
| Group 2 | | | |
| Experimental | 0.45 | 50 | 50 |
| Group 3 | | | |
| Experimental | 0.45 | 10 | 90 |
| Group 4 | | | |
| Experimental | 0.45 | 0 | 100 |
| Group 5 | | | |

Each replicate was housed in an individual stainless-steel cage (200 cm long×100 cm wide×70 cm high) with mesh ground and equipped with nipple drinkers and feeder. All cages were randomly distributed in a farmhouse under constant lighting of 24 h. All birds were reared in an environmental controlled net rearing system (31-36° C.) during 1-14 days of age, where the temperature was gradually decreased to 26° C. Birds were fed ad libitum and given free access to water throughout the experiment. During the experimental period, the health condition of the broilers was monitored every day, and the death and culling condition and the feed consumption were recorded by replicates, and the body weight were weighed when the experiment was ended. The average body weight, relative growth yield and feed conversion ratio of the experimental roosters were calculated with reference to the PRC Agriculture Industry Standard—Poultry Production Performance (NY/T 823-2004), and the synergistic effect comparison results of the medium-chain fatty acid monoglyceride in different ratios on broiler production performance are shown in Table 2.

TABLE 2

| | Average | Feed | Daily | |
|---|---|---|---|---|
| | Slaughtering | Conversion | Weight | Daily Feed |
| Group | Weight g | Ratio | Gain g | Intake |
| Control | 2522.51 ± 116.82 | 2.236 ± 0.046 | 39.42 ± 1.85 | 88.54 ± 2.81 |
| Group | | | | |
| Experi- | 2581.45 ± 60.13 | 2.233 ± 0.013 | 40.37 ± 0.95 | 88.44 ± 6.36 |
| mental | | | | |
| Group 1 | | | | |
| Experi- | 2624.06 ± 147.74 | 2.160 ± 0.059 | 41.04 ± 2.34 | 87.81 ± 3.63 |
| mental | | | | |
| Group 2 | | | | |
| Experi- | 2577.77 ± 109.99 | 2.195 ± 0.040 | 40.29 ± 1.74 | 86.19 ± 4.73 |
| mental | | | | |
| Group 3 | | | | |
| Experi- | 2533.17 ± 68.98 | 2.213 ± 0.051 | 39.60 ± 1.09 | 86.33 ± 5.97 |
| mental | | | | |
| Group 4 | | | | |
| Experi- | 2526.79 ± 124.57 | 2.270 ± 0.031 | 39.49 ± 1.98 | 87.66 ± 4.28 |
| mental | | | | |
| Group 5 | | | | |

Compared with the control group, both the average slaughtering weight and daily weight gain of broilers in Experimental Group 1 are notably increased, while the feed conversion ratio and daily feed intake change little, indicating that the glycerol monolaurate can promote the production performance of the broilers. Compared with the control group, the average slaughtering weight, feed ratio, daily weight gain and daily feed intake of the broilers in Experimental Group 5 change little, indicating that the glycerol monodecanoate has little effect on the production performance of the broilers when added alone. The feed ratios of Experimental Groups 2, 3, and 4 are all notably lower than that of the control group, Experimental Group 2 and Experimental Group 5, indicating that compounding the glycerol monolaurate and the glycerol monodecanoate may notably improve the feed utilization rate of the broilers, and effectively reduce the feed ratio. The average slaughtering weights of Experimental Groups 2, 3, and 4 are all higher than those of the control group and Experimental Group 5, wherein Experimental Group 2 has the highest average slaughtering weight, indicating that compounding the glycerol monolaurate and the glycerol monodecanoate may notably improve the average slaughtering weight of broilers. Notably, when the addition amount of the glycerol monodecanoate is relatively high, the composite additive has little influence on the average slaughtering weight of the broilers, and has a quite obvious effect on reducing the feed ratio; when the ratio between the two is appropriate, the production performance of the broilers and the feed conversion ratio may be notably improved, exhibiting a significant synergistic effect.

At the end of the experiment, three broilers with similar body weights were selected from each replicate for slaughtering, half eviscerated yield, eviscerated yield, leg muscle yield and breast muscle yield of experimental broilers were calculated with reference to Chinese agricultural industry standard NY/T 823-2004, and the synergistic effect comparison results of the medium-chain fatty acid monoglyceride in different ratios on broiler slaughtering performance are shown in Table 3.

TABLE 3

| | Dressing | Half | | | Breast |
|---|---|---|---|---|---|
| | Percentage | Eviscerated | Eviscerated | Leg Muscle | Muscle |
| Group | % | Yield % | Yield % | yield % | yield % |
| Control Group | 90.78 ± 0.48 | 85.91 ± 0.84 | 78.68 ± 1.87 | 14.15 ± 1.26 | 17.75 ± 1.06 |
| Experimental | 90.64 ± 1.28 | 85.44 ± 1.88 | 78.40 ± 1.86 | 14.93 ± 0.62 | 18.28 ± 0.81 |
| Group 1 | | | | | |
| Experimental | 90.66 ± 1.08 | 85.95 ± 1.11 | 78.34 ± 1.74 | 15.70 ± 0.71 | 18.37 ± 0.79 |
| Group 2 | | | | ** | |
| Experimental | 90.35 ± 1.01 | 85.55 ± 1.27 | 77.94 ± 3.45 | 15.26 ± 0.90 | 18.33 ± 0.80 |
| Group 5 | | | | * | |

NOTE:
all the data is average value ± standard deviation;
* in the same column represents having significant difference, p < 0.05.

Given the significant change in the production performance of Experimental Groups 1, 2, and 5, the researcher specifically analyzed the change conditions in the slaughtering property of Experimental Groups 1, 2, and 5 (Table 3). The results indicate that the leg muscle yield and the breast muscle yield of Experimental Group 1 are both notably increased compared to the control group, indicating that the use of glycerol monolaurate alone has a significant promotion effect on the chicken yield of broilers. The breast muscle yield and the leg muscle yield of Experimental Group 5 are both higher than those of the control group and Experimental Group 1, indicating that the use of glycerol monodecanoate alone may also increase the chicken yield of broilers, and the effect is better than that of glycerol monolaurate. The breast muscle yield and the leg muscle yield of Experimental Group 2 are the highest with respect to other groups, and the leg muscle yield thereof is notably higher than that of the control group, indicating that the compounded use of the glycerol monolaurate and the glycerol monodecanoate may synergistically improve the slaughtering performance of broilers.

Combining Table 2 and Table 3, it may show that the compounded use of the glycerol monolaurate and the glycerol monodecanoate may both improve the production performance of broilers, and improve the chicken yield.

### Example 2

1050 1-day old male Lingnan yellow broilers with similar body weights were selected, and were randomly divided into 7 groups, each group was provided with 6 replicates, and each replicate included 25 broiler. The control group was fed with the basal feed, and Experimental Groups 1, 3, and 5 were fed with the basal feed added with the feed additive in mass fraction of 0.3‰, 0.45‰, 0.60‰, of which the formulation was: a carrier (silicon dioxide) in a content of 20%, and medium-chain fatty acid monoglyceride in a content of 80% in mass percentage, wherein a mixing ratio of the glycerol monolaurate to the glycerol monodecanoate was 1:0.

Experimental Groups 2, 4, and 6 were fed with the basal feed added with the feed additive in mass fraction of 0.3‰, 0.45‰, 0.60‰, of which the formulation was: a carrier (silicon dioxide) in a content of 20%, and mixed medium-chain fatty acid monoglyceride in a content of 80% in mass percentage, wherein a mixing ratio of the glycerol monolaurate to the glycerol monodecanoate was 2:1.

The breeding and sampling manners were the same as those in Example 1. The pH and drip loss of breast meat of experimental broilers were measured with reference to Chinese agriculture Industry Standard—Technical Specification for Pig Muscle Quality Assay (NY/T 821-2004).

The effect of the addition amount of medium-chain fatty acid monoglyceride on the production performance of broilers and synergistic effect comparison results are shown in Table 4:

TABLE 4

| | Addition | Average | | Daily | |
|---|---|---|---|---|---|
| | Amount | Slaughtering | | Weight | Daily Feed |
| Group | (‰) | Weight g | Feed Ratio | Gain g | Intake g |
| Control | | 2279.37 ± 32.50 | 2.153 ± 0.012 | 40.01 ± 0.58 | 86.67 ± 2.45 |
| Group | | | | | |
| Experimental | 0.30 | 2328.86 ± 55.41 | 2.149 ± 0.012 | 40.89 ± 0.98 | 89.78 ± 2.20 |
| Group 1 | | | | | |
| Experimental | | 2397.50 ± 50.63* | 2.127 ± 0.008 | 42.12 ± 2.11 | 90.60 ± 4.00 |
| Group 2 | | | | | |
| Experimental | 0.45 | 2336.64 ± 48.59 | 2.135 ± 0.049 | 41.43 ± 1.15 | 89.78 ± 2.20 |
| Group 3 | | | | | |
| Experimental | | 2366.57 ± 55.15 | 2.155 ± 0.086 | 41.56 ± 0.98 | 87.44 ± 2.13 |
| Group 4 | | | | | |
| Experimental | 0.60 | 2369.48 ± 71.62 | 2.107 ± 0.054 | 41.61 ± 1.28 | 86.78 ± 1.32 |
| Group 5 | | | | | |
| Experimental | | 2374.63 ± 54.18* | 2.149 ± 0.023 | 41.71 ± 0.97 | 92.28 ± 2.75 |
| Group 6 | | | | | |

NOTE:
all the data is average value ± standard deviation;
and * in the same column represents having significant difference from the control group, p < 0.05.

From the results of Table 4, it is seen that the average weight, the daily weight gain and the daily feed intake of broilers of Experimental Groups 1, 2, 3, 4, 5 and 6 are all higher than that of the control group, indicating that when the addition amount is 0.30-0.60‰, the glycerol monolaurate and the mixed medium-chain fatty acid monoglyceride both have significant promotion effect on the production performance of broilers. In addition, at three addition levels, the promotion effect of the composite medium-chain fatty acid monoglyceride on the production performance of broilers is superior to the effect of using the glycerol monolaurate alone, which indicates that when the addition amount is 0.3‰˜0.6‰, the mixed medium-chain fatty acid monoglyceride has synergistic promotion effect on the production performance of broilers. The average weight, the daily weight gain and the feed ratio of broilers in Experimental Group 5 are all better than those of Experimental Group 1 and Experimental Group 3, indicating that the optimal addition amount is 0.6‰ when glycerol monolaurate is added alone. The average weight and the daily weight gain of broilers in Experimental Group 2 are both better than those of Experimental Group 4 and Experimental Group 6, indicating that the effect is optimal when the addition amount of the composite medium-chain fatty acid monoglyceride is 0.30‰.

The effect of the medium-chain fatty acid monoglyceride addition amount on the slaughtering performance of broilers and chicken breast quality and synergistic effect comparison results are showed in Table 5.

TABLE 5

| | | Experimental | Experimental |
|---|---|---|---|
| Item | Control Group | Group 1 | Group 2 |
| dressing | 91.09 ± 0.33 | 91.78 ± 0.52* | 91.25 ± 0.55 |
| percentage % | | | |
| eviscerated yield % | 79.13 ± 0.95 | 80.62 ± 0.43* | 80.11 ± 0.67 |
| leg muscle yield % | 16.82 ± 0.39 | 17.49 ± 0.67 | 17.97 ± 0.63* |
| breast muscle | 14.11 ± 0.62 | 14.82 ± 0.55* | 14.89 ± 0.77 |
| yield % | | | |
| drip loss % | 2.80 ± 0.05 | 2.90 ± 0.18 | 2.28 ± 0.33* |
| pH1 | 5.70 ± 0.10 | 5.65 ± 0.04 | 5.67 ± 0.06 |
| pH24 | 5.42 ± 0.05 | 5.48 ± 0.06 | 5.53 ± 0.03* |
| total fatty acid | 44.71 ± 6.32 | 45.04 ± 6.78 | 49.50 ± 8.58 |
| (mg/g dry base) | | | |
| total amino acid | 66.22 ± 7.32 | 77.58 ± 20.25 | 76.71 ± 5.46* |
| (mg/g dry base) | | | |
| flavor amino acid | 24.84 ± 2.66 | 28.92 ± 6.86 | 38.35 ± 2.00* |
| (mg/g dry base) | | | |

NOTES:
pH1 is the acidity and alkalinity of chicken breast meat within 1 hour after slaughtering, and pH24 is the acidity and alkalinity of chicken breast meat after being refrigerated for 24 hours after slaughtering.
All the data is average value ± standard deviation;
and * in the same column represents having significant difference from the control group, p < 0.05.

From the results in Table 5, it is seen that Experimental Group 1 and Experimental Group 2 both have notably improved dressing percentage, eviscerated yield, leg muscle yield and breast muscle yield of broilers, but the two are not notably different.

The drip loss of Experimental Group 2 is notably lower than that of the control group, pH24 is notably higher than that of the control group, while the drip loss and pH24 of Experimental Group 1 are not notably different from those of the control group, indicating that the mixed medium-chain fatty acid glyceride has significant improvement effect on the chicken quality of broilers. Meanwhile, the total fatty acids, total amino acids and flavor amino acids of broilers of Experimental Groups 1 and 2 are notably increased compared with those of the control group, and the total amino acid and flavor amino acid increments of broilers of Experimental Group 2 are notably increased compared with those of Experimental Group 1, indicating that the composite medium-chain fatty acid monoglyceride also has significant synergistic effect on improvement of the flavor of broilers, and particularly when the mixing ratio of the glycerol monolaurate to the glycerol monodecanoate is 2:1, the synergistic effect is most pronounced.

### Example 3

10000 1-day old male Lingnan yellow broilers with similar body weight were selected, and were randomly divided into 2 groups, 5000 roosters in each group. The control group was fed with the basal feed, and the experimental group was fed with the basal feed added with the feed additive in mass fraction of 0.3‰, of which the formulation is: a carrier (silicon dioxide) in a content of 20%, and medium-chain fatty acid monoglyceride in a content of 80% in mass percentage, wherein a compounding ratio of the glycerol monolaurate to the glycerol monodecanoate is 3:1.

The breeding and sampling manners were the same with Example 2.

The results of effect of the medium-chain fatty acid monoglyceride on production performance of broilers are shown in following Table 6.

TABLE 6

| | Average | Feed | Feed | |
|---|---|---|---|---|
| | Slaughtering | Conversion | Consumption | |
| Group | Weight (g) | Ratio | Amount (g) | Mortality (%) |
| Control Group | 2600 | 2.500 | 6200 | 4.55 |
| Experimental | 2686 | 2.465 | 6250 | 4.04 |
| Group | | | | |

NOTES:
all the data is average value ± standard deviation;
* represents two groups having significant difference, p < 0.05.

Compared with the control group, the experimental group broilers are increased by 3.31% in average weight, decreased by 1.4% in the feed conversion ratio, and decreased by 11.21% in the mortality, moreover, the broilers in the experimental group have good uniformity, high activity, a small drug amount, and easy management.

The effect of the composite medium-chain fatty acid monoglyceride on apparent digestibility of nutrients in broilers is shown in Table 7.

TABLE 7

| Group | Crude Protein (%) | Crude Fat (%) |
|---|---|---|
| Control Group | 52.83 ± 1.46 | 75.53 ± 3.60 |
| Experimental | 53.65 ± 2.85 | 75.16 ± 0.60 |
| Group | | |

The data in Table 7 show that the composite medium-chain fatty acid glyceride increases the digestibility of crude protein in broiler feed by 1.55%, which may be the cause of high broiler production performance, good quality and high feed efficiency.

The effect of the composite medium-chain fatty acid monoglyceride on the chicken and chicken broth taste of broilers are shown in Table 8.

TABLE 8

| Sensory Score and | | |
|---|---|---|
| Subjective | | |
| Evaluation | Control Group | Experimental Group |
| weighted total score | 7.8 | 8.3 |
| overall sensation | 7.7 | 8.2 |
| chicken taste | 7.2 | 8.2 |
| chicken broth taste | 7.7 | 8.1 |
| chicken taste | 2/22 tender, 15/22 | 7/22 tender, 5/22 relatively |
| (number of | relatively muddy, | muddy, relatively dry, and |
| people/total number | relatively dry, and | relatively hard |
| of people) | relatively hard | |
| chicken broth taste | 1/22 not tasty, 2/22 tasty, | 1/22 not tasty, 4/22 tasty, |
| (number of | 4/22 strong taste and | 5/22 strong taste and |
| people/total number | delicious broth, 1/22 light | delicious broth, 7/22 light |
| of people) | taste and not delicious, | taste and not delicious, 3/22 |
| | 7/22 sour | sour |

Compared with the control group, the sensory score of the broilers in the experimental group is notably higher than that of the control group in weighted total score, overall sensation, chicken taste, chicken broth taste and other items, indicating that the chicken obtained from feeding with the medium-chain fatty acid monoglyceride is notably improved both in mouthfeel and flavor after cooking. The results of sensory evaluation show that the chicken in the experimental group has good tenderness and sufficient freshness.

### Laying Hen Example

The basal feed for laying hens adopted the following formulation: corn 62.90%, soybean meal 23.55%, stone powder 7.93%, salt 0.30%, fish oil 0.03%, rapeseed oil 0.59%, and a premix feed 4.70% in mass percentage. The nutritional ingredients of the feed raw materials were: crude protein 16.10%, crude fat 2.86%, total calcium 3.73%, total phosphorus 0.60%, lysine 0.81%, and methionine+cysteine 0.65%.

In the above, the nutritional ingredients of the premix feed were: vitamin A (10,000 IU), vitamin E (200 IU), vitamin B1 (4 mg), vitamin B2 (6 mg), vitamin B6 (5 mg), vitamin B12 (1 mg), vitamin K3 (3 mg), biotin (0.5 mg), folate (3 mg), pantothenic acid (20 mg), nicotinic acid (20 mg), copper (10 mg), iron (100 mg), manganese (100 mg), zinc (100 mg), and selenium (0.4 mg) in 1 kg of the premix feed.

### Example 4

756 54-week old Hy-Line Brown laying hens were randomly divided into 6 groups, each group had 6 replicates, and each replicate had 21 hens.

The control group was fed with the basal feed, and Experimental Groups 1, 2, 3, 4 and 5 were fed with the basal feed added with the feed additive, respectively, and formulations are shown in Table 9.

TABLE 9

| | Addition | Glycerol | Glycerol |
|---|---|---|---|
| | Amount | monolaurate | monodecanoate |
| Group | (‰) | (%) | (%) |
| Control Group | 0 | 0 | 0 |
| Experimental | 0.30 | 100 | 0 |
| Group 1 | | | |
| Experimental | 0.30 | 90 | 10 |
| Group 2 | | | |
| Experimental | 0.30 | 50 | 50 |
| Group 3 | | | |
| Experimental | 0.30 | 10 | 90 |
| Group 4 | | | |
| Experimental | 0.30 | 0 | 100 |
| Group 5 | | | |

The experimental hens were fed in a manner of step-type cage rearing, and fed twice each day. Eggs were picked once a day. Feeding, water drinking, cleaning, disinfection, and epidemic prevention were performed according to chicken field measures. The entire experimental period was divided into two phases, 42 days in total, with 14 days of pre-feeding period, and 28 days of formal experimental period. The egg samples were randomly selected at the end point of the experiment, with 5 eggs in each replicate, to analyze and measure the quality of the eggs.

The results of effect of the composite medium-chain fatty acid monoglyceride on the egg production performance of Hy-Line Brown laying hens are shown in Table 10.

TABLE 10

| | | Feed | | Percentage |
|---|---|---|---|---|
| | Laying | Conversion | Average Egg | of Broken |
| Group | yield (%) | Ratio | Weight (g) | Eggs (%) |
| Control Group | 86.4 ± 2.2 | 1.972 ± 0.062 | 62.34 ± 0.48 | 0.78 ± 0.34 |
| Experimental | 87.2 ± 2.9 | 1.936 ± 0.057 | 62.99 ± 1.31 | 0.93 ± 0.54 |
| Group 1 | | | | |
| Experimental | 90.9 ± 2.8* | 1.881 ± 0.055* | 62.54 ± 0.88 | 0.85 ± 0.45 |
| Group 2 | | | | |
| Experimental | 89.6 ± 1.2* | 1.873 ± 0.020* | 63.70 ± 0.77* | 0.83 ± 0.43 |
| Group 3 | | | | |
| Experimental | 89.7 ± 1.7* | 1.906 ± 0.059 | 62.59 ± 1.05 | 0.61 ± 0.31 |
| Group 4 | | | | |
| Experimental | 88.7 ± 0.9 | 1.915 ± 0.010 | 63.03 ± 0.72 | 0.75 ± 0.30 |
| Group 5 | | | | |

Compared with the control group, the laying yield of laying hens in Experimental Group 1 is slightly higher and the feed conversion ratio is decreased, indicating that glycerol monolaurate can promote the production performance and feed utilization rate of the laying hens, but its effect is unfavorable. The laying yield of laying hens in Experimental Group 5 is notably higher than that in the control group, and the feed conversion ratio is also relatively low, but neither of the two indicators has statistically difference, indicating that the glycerol monodecanoate also can promote the production performance and feed utilization rate of Hy-Line Brown laying hens, and its effect is better than the glycerol monolaurate. The laying yields of Experimental Groups 2, 3, and 4 are all higher than that of the control group, and higher than those of Experimental Groups 1 and 5; the feed conversion ratio of Experimental Groups 2, 3, and 4 are all notably lower than that of the control group, and lower than those of Experimental Groups 1 and 5; these results indicate that the composite medium-chain fatty acid has significant synergistic effect on improving the egg production performance and feed utilization rate of the laying hens. It is seen from the experiment results that when the two are compounded at the ratio in Experimental Group 2, the laying yield of the laying hens can be increased to a maximum extent, while when the two are compounded at the ratio in Experimental Group 3, the feed conversion ratio can be decreased to a maximum extent, and the weight of individual eggs can be increased notably, thus increasing the yield.

The effect of the composite medium-chain fatty acid monoglyceride on the egg quality of Hy-Line Brown laying hens is shown in Table 11.

TABLE 11

| | | | Egg Shell | Egg Shell |
|---|---|---|---|---|
| | Albumen | Haugh | Strength | Thickness |
| Group | Height (mm) | Unit | kgf/m² | (mm) |
| Control Group | 8.65 | 90.30 | 3.98 | 0.363 |
| Experimental | 8.68 | 91.5 | 4.73* | 0.423* |
| Group 1 | | | | |
| Experimental | 9.25* | 95.10* | 4.58* | 0.411* |
| Group 2 | | | | |
| Experimental | 8.93 | 94.50* | 4.50* | 0.408* |
| Group 3 | | | | |
| Experimental | 8.78 | 89.20 | 4.40* | 0.386* |
| Group 4 | | | | |
| Experimental | 8.92 | 92.45 | 4.46* | 0.383* |
| Group 5 | | | | |

Compared with the control group, the egg shell strength and the egg shell thickness of eggs in Experimental Group 1 are notably higher than those in the control group, wherein the egg shell strength and the egg shell thickness are important indicators of egg quality, and increased egg shell strength and increased egg shell thickness may effectively avoid loss of eggs during production and transportation, and can ensure hygiene of fresh egg products to the maximum degree, indicating that the glycerol monolaurate has significant influence on the egg shell quality. For the eggs in Experimental Group 5, apart from the egg shell strength and the egg shell thickness that are notably changed with respect to the control group, the albumen height and Haugh unit thereof are also changed obviously. The albumen height and Haugh unit are important indicators reflecting the freshness of eggs, and they are very beneficial for maintaining the quality of eggs during storage, indicating that the glycerol monodecanoate has obvious influence on the egg white of eggs. The albumen height and Haugh unit of Experimental Groups 2 and 3 are both notably higher than those of the control group, and much higher than those of Experimental Groups 1 and 5. These results indicate that the composite medium-chain fatty acid has significant synergistic effect on improving the egg quality. Feeding the laying hens with the composite medium-chain fatty acid monoglyceride may render the best egg quality in Experimental Group 2, and the albumen height and Haugh unit thereof are both higher than those in all other experimental groups, and the egg shell strength and the egg shell thickness are also notably superior to the control group.

### Pig Examples

The improvement on the production performance, the dressing percentage, and the pork quality of the pigs by the composite medium-chain fatty acid monoglyceride is further explained in combination with examples. In the examples, a plurality of feed additive formulations were tested, and all had excellent effects.

The basal feed for weaned pigs adopted the following formulation: corn 57%, soybean meal 25%, wheat meal 10.0%, fish meal 2.0%, soybean oil 2.0%, and a premix feed 4.0% in mass percentage. The nutritional ingredients of the feed raw materials were: crude protein 19.3%, lysine 1.26%, total calcium 0.68%, and total phosphorus 0.57%.

The basal feed of fattening pigs adopted the following formulation: corn 72.0%, soybean meal 20.0%, wheat meal 4.0%, stone powder 1.1%, calcium bicarbonate 1.4%, salt 0.3%, lysine 0.2%, and a premix feed 1.0% in mass percentage. The nutritional ingredients of the feed raw materials were: crude protein 15.81%, lysine 0.98%, total calcium 0.88%, and total phosphorus 0.57%.

In the above, the nutritional ingredients of the premix feed were: vitamin A (15,500 IU), vitamin D₃ (3000 IU), vitamin E (100 IU), vitamin B1 (3 mg), vitamin B2 (8 mg), vitamin B6 (5 mg), vitamin B12 (0.04 mg), vitamin K3 (3 mg), vitamin C (160 mg), biotin (0.3 mg), folate (2.0 mg), pantothenic acid (20 mg), nicotinic acid (45 mg), copper (230 mg), iron (180 mg), manganese (50 mg), zinc (180 mg), iodine (0.5 mg), and selenium (0.2 mg) in 1 kg of the premix feed.

### Example 5

4500 weaned pigs with similar body weights (11.75±0.29 kg) were selected and randomly divided into 6 groups.

The control group was fed with the basal feed, Experimental Groups 1, 2, 3, 4 and 5 were fed with the basal feed added with the feed additive, respectively, and formulations are shown in Table 12.

TABLE 12

| | Addition | Glycerol | Glycerol |
|---|---|---|---|
| | Amount | monolaurate | monodecanoate |
| Group | (%) | (%) | (%) |
| Control Group | 0 | 0 | 0 |
| Experimental | 0.45 | 100 | 0 |
| Group 1 | | | |
| Experimental | 0.45 | 90 | 10 |
| Group 2 | | | |
| Experimental | 0.45 | 50 | 50 |
| Group 3 | | | |
| Experimental | 0.45 | 10 | 90 |
| Group 4 | | | |
| Experimental | 0.45 | 0 | 100 |
| Group 5 | | | |

During the experiment, the pigsty was kept clean and dry, the swines drank water and ate food freely, and were fed three times per day on time. The experimental period was 156 days in total. The initial body weights, feed intake, end-point body weights and the number of death and culling were recorded for the production performance analysis. The results of effect of the composite medium-chain fatty acid monoglyceride on the growth performance of the swines are shown in Table 13.

TABLE 13

| | | | Feed | Daily | |
|---|---|---|---|---|---|
| | Initial | End-Point | Conversion | Weight | Survival |
| Group | Weight (kg) | Weight (kg) | Ratio | Gain (g) | rate (%) |
| Control | 11.99 | 146.56 | 2.870 | 0.863 | 93.36 |
| Group | | | | | |
| Experimental | 11.27 | 145.88 | 2.686 | 0.857 | 97.78 |
| Group 1 | | | | | |
| Experimental | 11.93 | 148.94 | 2.619 | 0.884 | 96.54 |
| Group 2 | | | | | |
| Experimental | 11.88 | 148.62 | 2.662 | 0.871 | 97.56 |
| Group 3 | | | | | |
| Experimental | 11.50 | 147.78 | 2.683 | 0.874 | 98.02 |
| Group 4 | | | | | |
| Experimental | 11.89 | 142.20 | 2.632 | 0.835 | 95.60 |
| Group 5 | | | | | |

From the results of Table 13, it is seen that the average weights of swines in Experimental Groups 1 and 5 are slightly less than that in the control group at the end of the experiment, but the difference is not large, while the feed conversion ratio is notably lower than that in the control group, and the survival rate is notably higher than that the control group, indicating that glycerol monolaurate and the glycerol monodecanoate can promote the production performance and health of swines. At the end of the experiment, the body weights, the feed conversion ratio, the average daily weight gain and the survival rate of the swines in Experimental Groups 2, 3, and 4 are all higher than those in the control group, and the end-point body weights and the average daily weight gain of Experimental Groups 2, 3 and 4 are both higher than those in Experimental Groups 1 and 5, indicating that the compounded glycerol monolaurate and glycerol monodecanoate also promote the production performance of swines, and the effects thereof are obviously superior to that of the two when used alone, indicating that there is a significant synergistic effect when the two are used in combination. Notably, in the 6 experimental groups, Experimental Group 2 exhibits the maximum end-point body weight and average daily weight gain, and the minimum feed conversion ratio, indicating that the synergistic effect of the two is optimal at this time.

### Example 6

1100 weaned pigs with similar body weights (7.445 kg) were selected and randomly divided into 2 groups. The control group was fed with the basal diet, and the experimental group was fed with the basal diet added with 0.45‰ composite medium-chain fatty acid monoglyceride (carrier 20%+glycerol monolaurate 60%+glycerol monodecanoate 20%).

The entire experimental period was 140 days in total. During the experiment, the pigsty was kept clean and dry, the swines drank water and ate food freely, and were fed three times per day on time. In the experimenting process, the initial body weights, feed intake, 70-day body weights, end-point body weights and the number of death and culling were recorded for the production performance analysis. In the first half of the experiment (70 days), the results of effect of the composite medium-chain fatty acid monoglyceride on the production performance of the swines are shown in Table 14.

TABLE 14

| | Initial | Average | Total Weight | Average Daily | Absolute |
|---|---|---|---|---|---|
| | Weight | Weight | Gain (kg/per | Weight Gain | Growth |
| Group | (kg) | (kg) | piglet) | (kg/per piglet) | yield % |
| Control | 7.15 | 41.48 | 34.34 | 0.48* | 480.39 |
| Group | | | | | |
| Experimental | 6.98 | 45.35* | 38.37* | 0.54* | 549.45* |
| Group | | | | | |

From Table 14, it can be seen that after being fed with the composite medium-chain fatty acid monoglyceride for 70 days, the weaned pigs in the experimental group are notably increased in the average weight, total weight gain, average daily weight gain and absolute growth yield by 9.33%, 11.74%, 12.50% and 14.38% compared with the control group (p<0.05), indicating that the composite medium-chain fatty acid monoglyceride may notably improve the production performance of the weaned pigs.

The effect of the composite medium-chain fatty acid monoglyceride on the production performance of swines during the entire experiment period (140 days) is shown in Table 15.

TABLE 15

| | Initial | End-point | | | |
|---|---|---|---|---|---|
| | Weight | Weight | Feed- | | Dressing |
| | (kg/per | (kg/per | conversion | Mortality | Percentage |
| Group | piglet) | piglet) | ratio | % | % |
| Control | 7.15 | 115.8 | 2.46 | 10 | 81.29 |
| Group | | | | | |
| Experimental | 6.98 | 119.3 | 2.35 | 8.36 | 82.15 |
| Group | | | | | |

From Table 15, it can be seen that swines the average weight and dressing percentage of swines fed with the composite medium-chain fatty acid monoglyceride increased by 3.02% and 1.06% compared with those in the control group, indicating that the composite medium-chain fatty acid monoglyceride may increase the pork production yield while promoting the growth of the swines. The feed conversion ratio of the swines in the experimental group is decreased by 4.47% compared with that in the control group, indicating that the medium-chain fatty acid monoglyceride may notably increase the feed utilization rate. The mortality in the experimental group is reduced by 16.4% compared with that in the control group, indicating that the medium-chain fatty acid monoglyceride further has a significant promotion effect on the health of swines. In addition, according to observation, compared with the control group, the experimental group has uniform growth, fast feeding, less diseases and good management.

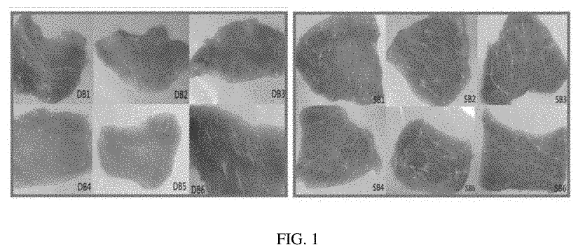

Photographs of Longissimus dorsi of swines in the control group (DB1-6) and the experimental group (SB1-6) are shown in FIG. 1, and it can be seen from the photographs that the snowflake patterns of the Longissimus dorsi in the experimental group are clear and visible, the intermuscular fat is notably more than that in the control group, and the muscle color is also redder than that in the control group. Sensory evaluation results indicate that the pork in the experimental group has better taste and mouthfeel, and is fat but not greasy.

The effect of the composite medium-chain fatty acid monoglyceride on the components of Longissimus dorsi swines is shown in Table 16.

TABLE 16

| | Fat Content | Protein Content |
|---|---|---|
| | (based on wet | (based on dry |
| Group | base, %) | base, %) |
| Control | 2.82 ± 0.57 | 82.74 ± 3.31 |
| Group | | |
| Experimental | 3.13 ± 0.95 | 84.64 ± 0.72 |
| Group | | |

The analysis results of the Longissimus dorsi components are consistent with those in the photographs, the intermuscular fat content of the Longissimus dorsi in the experimental group is 10.99% (3.13% vs 2.82%) more than that in the control group, the protein content is 2.30% (84.64% vs 82.74%) more than that in the control group, and feeding with the composite medium-chain fatty acid monoglyceride may notably improve the pork quality.

### Example 7

120 weaned pigs with similar body weights (7.445 kg) were selected and randomly divided into 2 groups. The control group was fed with the basal diet, and the experimental group was fed with the basal diet added with 0.45‰ composite medium-chain fatty acid monoglyceride (glycerol monolaurate 75%+glycerol monodecanoate 25%).

The entire experimental period was 140 days in total. During the experiment, the pigsty was kept clean and dry, the swines drank water and ate food freely, and were fed three times per day on time. In the experimenting process, the initial body weights, feed intake, and end-point body weights were recorded for the production performance analysis. The results of effect of the composite medium-chain fatty acid monoglyceride on the growth property of the swines are shown in Table 17.

TABLE 17

| | Initial | End-Point | Average Daily | | Feed |
|---|---|---|---|---|---|
| | Weight | Weight | Weight Gain | Daily Feed | Conversion |
| Group | (kg) | (kg) | (g/d) | Intake (g/d) | Ratio |
| Control Group | 10.28 ± 0.08 | 17.80 ± 0.95 | 268.33 ± 32.96 | 506.00 ± 27.50 | 1.90 ± 0.13 |
| Experimental | 10.27 ± 0.58 | 19.57 ± 1.26 | 332.14 ± 26.31 | 493.45 ± 5.74 | 1.49 ± 0.1b |
| Group | | | | | |

After being fed with the composite medium-chain fatty acid monoglyceride for 28 days, the weaned pigs in the experimental group were increased in the average weight and average daily weight gain by 1.77 kg and 63.81 g compared with those in the control group, and the feed conversion ratio was decreased by 21.58% compared with that in the control group, indicating that the composite medium-chain fatty acid monoglyceride not only can promote the production performance of the weaned pigs, but also can improve the utilization efficiency of the feed.

The effect of the composite medium-chain fatty acid monoglyceride on the serum health index of weaned pigs is shown in Table 18.

TABLE 18

| | Total | Blood | Alkaline | Blood | | |
|---|---|---|---|---|---|---|
| | Proteins | Glucose | Phosphatase | Calcium | Albumin | Triglyceride |
| Group | mmol/L | mmol/L | U/L | mmol/L | mmol/L | mmol/L |
| Control | 44.32 ± 0.92 | 5.07 ± 0.1 | 130.89 ± 35.27 | 2.54 ± 0.02 | 22.54 ± 0.61 | 1.32 ± 0.15 |
| Group | | | | | | |
| Experimental | 48.72 ± 1.55* | 5.73 ± 0.12* | 198.78 ± 12.12* | 2.74 ± 0.11* | 25.72 ± 1.36* | 1.15 ± 0.09* |
| Group | | | | | | |

After being fed with the composite medium-chain fatty acid monoglyceride for 28 days, the contents of total proteins and blood glucose in serum of the weaned pigs in the experimental group are both notably higher than those in the control group, which may be because the additive promotes the utilization ratio of proteins and nutrients in the feed for weaned pigs; the alkaline phosphatase and blood calcium contents of the weaned pigs in the experimental groups are notably higher than those in the control group, which indicates that the additive may notably promote the use of calcium by the swines, so as to promote the growth and development of piglet skeletons; the serum albumin content in the experimental group is notably higher than that in the control group, while the triglyceride content is notably lower than that in the control group, indicating that the swines fed with the composite medium-chain fatty acid monoglyceride are more healthy.

In summary, the composite medium-chain fatty acid monoglyceride may promote the production performance of weaned pigs, improve the utilization efficiency of the feed, promote the growth and development of piglet skeletons, and meanwhile further have a positive effect on the health of the swines.

### Example 8

2100 carps with strong physique, uniform specification and average body mass of about 67 g were selected, and equally divided into 6 groups, each group was provided with 5 replicates, and each replicate included 70 carps. The experimental carps were fed separately in groups, wherein the control group was fed with the basal diet, and the experimental group was fed with the basal diet added with the composite medium-chain fatty acid monoglyceride, and the formulations are as shown in Table 19.

TABLE 19

| | Addition | Glycerol | Glycerol |
|---|---|---|---|
| | Amount | monolaurate | monodecanoate |
| Group | (%) | (%) | (%) |
| Control Group | 0 | 0 | 0 |
| Experimental | 0.45 | 100 | 0 |
| Group 1 | | | |
| Experimental | 0.45 | 90 | 10 |
| Group 2 | | | |
| Experimental | 0.45 | 50 | 50 |
| Group 3 | | | |
| Experimental | 0.45 | 10 | 90 |
| Group 4 | | | |
| Experimental | 0.45 | 0 | 100 |
| Group 5 | | | |

The carp basal feed adopted the following formulation: fish meal 5%, soybean meal 28%, cottonseed meal 8%, rapeseed meal 15%, corn protein meal 8%, bran coat 27%, fish oil 6.5%, calcium dihydrogen phosphate 1.0%, choline chloride 0.5%, and a premix feed 1.0% in mass percentage. The nutritional ingredients of the feed raw materials were: crude protein 38.57%, crude fat 9.75%, crude ash 6.70%, and crude fiber 4.86%.

In the above, the nutritional ingredients of the premix feed were: vitamin A (10,000 IU), vitamin D3 (3000 IU), vitamin E (150 IU), vitamin K3 (3 mg), vitamin B1 (20 mg), vitamin B2 (20 mg), vitamin B3 (100 mg), vitamin B6 (22 mg), vitamin B12 (0.15 mg), vitamin C (500 mg), biotin (0.1 mg), folate (8 mg), and inositol (500 mg) in 1 kg of the premix feed.

The entire experimental period had 72 days in total. During the experiment, the carps were fed 3 times each day (07:00, 12:00, 17:00), wherein the daily feeding yield was 3.0%-5.0% of the fish body mass, and adjusted according to the water temperature and intake condition, so that the feed repeatedly fed could be eaten up within 10 min, without residual feed, and basically consistent feeding amount was kept for each net cage. The feeding amount was recorded every day, and the carps were weighed according to replicates after the experiment was ended. Bait coefficient=feed consumption amount/(initial total weight−end-point total weight).

The results of effect of the composite medium-chain fatty acid monoglyceride on production performance of the carps are shown in Table 20.

TABLE 20

| | Initial | End-point | Total Weight | |
|---|---|---|---|---|
| | Average | Average | Gain (g/per | Bait |
| Group | Weight (g) | Weight (g) | carp) | Coefficient |
| Control | 67 ± 1 | 208 ± 13 | 141 ± 12 | 1.580 ± 0.129 |
| Group | | | | |
| Experimental | 67 ± 1 | 210 ± 9 | 143 ± 9 | 1.548 ± 0.096 |
| Group 1 | | | | |
| Experimental | 67 ± 1 | 222 ± 7 | 155 ± 7* | 1.427 ± 0.070* |
| Group 2 | | | | |
| Experimental | 68 ± 1 | 220 ± 10 | 153 ± 9* | 1.442 ± 0.020* |
| Group 3 | | | | |
| Experimental | 67 ± 1 | 215 ± 14 | 154 ± 7* | 1.420 ± 0.068* |
| Group 4 | | | | |
| Experimental | 67 ± 1 | 220 ± 8 | 147 ± 13 | 1.509 ± 0.127 |
| Group 5 | | | | |

Compared with the control group, when the experiment was ended, the average weight and the total weight gain of the carps in Experimental Group 1 are slightly increased, and the bait coefficient is also slightly decreased, indicating that although the glycerol monolaurate has a promotion effect on the production performance of the carps, the effect is insignificant. The experimental result of Experimental Group 5 are highly similar to that of Experimental Group 1, but the bait coefficient is reduced more obviously, indicating that the glycerol monodecanoate has better effect on improving the feed utilization rate.

The average weight and total weight gain of Experimental Groups 2, 3, and 4 are notably higher than those in the control group, and higher than those in Experimental Groups 1 and 5; and the bait coefficients of Experimental Groups 2, 3, and 4 are notably reduced compared with that in the control group, and are obviously lower than those in Experimental Groups 1 and 5, which indicates that the composite medium-chain fatty acid monoglyceride has a significant promotion effect on the production performance and feed utilization rate of carps, and the compounded use of the glycerol monolaurate and the glycerol monodecanoate has a significant synergistic effect on the production performance of carps and feed utilization rate.

### Example 9

2400 grass carps with strong physique, uniform specification and average body mass of about 50 g were selected, and equally divided into 4 groups, each group was provided with 4 replicates, and each replicate included 150 grass carps. The experimental group were fed separately in groups, wherein the control group was fed with the basal diet, and the experimental group was fed with the basal diet added with 0.45‰ composite medium-chain fatty acid monoglyceride, and the formulations are as shown in Table 21.

TABLE 21

| | Addition | Glycerol | Glycerol |
|---|---|---|---|
| | Amount | monolaurate | monodecanoate |
| Group | (%) | (%) | (%) |
| Control Group | 0 | 0 | 0 |
| Experimental | 0.45 | 100 | 0 |
| Group 1 | | | |
| Experimental | 0.45 | 90 | 10 |
| Group 2 | | | |
| Experimental | 0.45 | 50 | 50 |
| Group 3 | | | |

The grass carp basal feed adopted the following formulation: soybean meal 18%, cottonseed meal 16%, rapeseed meal 18%, bran coat 10%, defatted rice bran 10%, wheat middling 22.45%, soybean oil 1%, fish meal 2%, calcium dihydrogen phosphate 1.5%, a premix feed 0.55%, and choline chloride 0.5% in mass percentage. The nutritional ingredients of the feed raw materials were: crude protein 32.5%, crude fat 5.6%, crude ash 6.6%, and water 10.5%.

In the above, the nutritional ingredients of the premix feed were: vitamin A (10,000 IU), vitamin D3 (3000 IU), vitamin E (150 IU), vitamin K3 (12.17 mg), vitamin B1 (20 mg), vitamin B2 (20 mg), vitamin B3 (100 mg), vitamin B6 (22 mg), vitamin B12 (0.15 mg), vitamin C (1000 mg), biotin (0.6 mg), folate (8 mg), inositol (500 mg), iodine (1.5 mg), cobalt (0.6 mg), copper (3 mg), iron (63 mg), magnesium (180 mg), manganese (11.45 mg), zinc (89 mg), and selenium (0.24 mg) in 1 kg of the premix feed.

The entire experimental period had 40 days in total. During the experiment, the grass carps were fed 3 times each day (07:00, 12:00, 17:00), wherein the daily feeding yield was 3.0%-5.0% of the fish body mass, and adjusted according to the water temperature and intake condition, so that the feed repeatedly fed could be eaten up within 10 min, without residual feed, and basically consistent feeding amount was kept for each net cage. The feeding amount was recorded every day, and the grass carps were weighed according to replicates after the experiment was ended. Bait coefficient=feed consumption amount/(initial total weight−end-point total weight).

The results of effect of the composite medium-chain fatty acid monoglyceride on production performance of the grass carps are shown in Table 22.

TABLE 22

| | Initial | | | |
|---|---|---|---|---|
| | Total | End-point | Total | |
| | Weight | Average | Weight | Bait |
| Group | (kg) | Weight (g) | Gain (kg) | Coefficient |
| Control Group | 50 ± 1 | 210 ± 30 | 160 ± 30 | 1.48 ± 0.09 |
| Experimental | 50 ± 1 | 230 ± 10* | 180 ± 15* | 1.64 ± 0.24 |
| Group 1 | | | | |
| Experimental | 50 ± 1 | 230 ± 10* | 180 ± 10* | 1.31 ± 0.07* |
| Group 2 | | | | |
| Experimental | 50 ± 1 | 220 ± 10 | 170 ± 10 | 1.31 ± 0.07* |
| Group 3 | | | | |

Compared with the control group, the end-point average weight and the total weight gain of the grass carps in Experimental Group 1 are both notably increased, but the bait coefficient is increased by 10.81% compared with that in the control group, indicating that feeding the grass carps with the feed containing 0.45‰ glycerol monolaurate can have significant promotion effect on the production performance of the grass carps, but has unfavorable effect on improving the utilization ratio of the feed. The grass carps in Experimental Group 2 and Experimental Group 3 have the end-point average weight and total weight gain both higher than those in the control group, and the bait coefficient notably reduced compared with that in the control group, indicating that the composite medium-chain fatty acid monoglyceride also has the function of notably promoting the growth of grass carps and feed utilization rate. In addition, the production performance of Experimental Groups 2 and 3 is not quite different from that in Experimental Group 1, but the bait coefficients of the two are much lower than that in Experimental Group 1, which indicates that the compounded use of the glycerol monolaurate and the glycerol monodecanoate can promote the production, and also can improve the feed efficiency, indicating that the composite medium-chain fatty acid monoglyceride has a synergistic effect.

### Example 10

1200 grass carps with strong physique, uniform specification and average body mass of about 50 g were selected, and equally divided into 3 groups, each group was provided with 4 replicates, and each replicate included 100 grass carps. The experimental grass carps were fed separately in groups, wherein the control group was fed with the basal diet, and the experimental group was fed with the basal diet added with 0.6‰ composite medium-chain fatty acid monoglyceride, and the formulations are as shown in Table 23.

TABLE 23

| | Addition | Glycerol | Glycerol |
|---|---|---|---|
| | Amount | monolaurate | monodecanoate |
| Group | (%) | (%) | (%) |
| Control Group | 0 | 0 | 0 |
| Experimental Group 1 | 0.60 | 75 | 25 |
| Experimental Group 2 | 0.60 | 50 | 50 |

The basal feed of the grass carps was the same as that in Example 9.

The entire experimental period had 21 days in total. During the experiment, the grass carps were fed 3 times each day (07:00, 12:00, 17:00), wherein the daily feeding yield was 3.0%-5.0% of the fish body mass, and adjusted according to the water temperature and intake condition, so that the feed repeatedly fed could be eaten up within 10 min without residual feed, and basically consistent feeding amount was kept for each net cage. The feeding amount was recorded every day, and the grass carps were weighed according to replicates after the experiment was ended. Bait coefficient=feed consumption amount/(initial total weight−end-point total weight).

The results of effect of the composite medium-chain fatty acid monoglyceride on production performance of the grass carps are shown in Table 24.

TABLE 24

| | | End-Point | Total | |
|---|---|---|---|---|
| | Initial | Average | Weight | Bait |
| Group | Weight (g) | Weight (g)) | Gain (g)) | Coefficient |
| Control Group | 326 ± 34 | 460 ± 46 | 134 ± 12 | 1.455 ± 0.010 |
| Experimental | 322 ± 31 | 466 ± 44 | 144 ± 13 | 1.337 ± 0.033* |
| Group 1 | | | | |
| Experimental | 327 ± 10 | 469 ± 17 | 142 ± 7 | 1.352 ± 0.012* |
| Group 2 | | | | |

It can be seen from the table that the grass carps in Experimental Groups 1 and 2 are slightly increased in the end-point average weight and total weight gain compared with the control group, but the difference is insignificant, indicating that when the addition amount of the feed additive is 0.60‰, the additive of the formulations in Experimental Group 1 and Experimental Group 2 does not have great influence on the production performance of the grass carps. However, the bait coefficients in Experimental Group 1 and Experimental Group 2 are notably reduced by 8.11% and 7.08% compared with that in the control group, indicating that when the addition amount of the feed additive is 0.60‰, the additive of the formulations in Experimental Group 1 and Experimental Group 2 can notably improve the utilization ratio of the feed for the grass carps.

### Example 11

20 Holstein cows having good body condition, similar daily milk production, and consistent weights and being in middle and later periods of lactation were selected, and randomly divided into 2 groups, with 10 cows in the control group and the experimental group, respectively. The control group was fed with the basal diet, and the experimental group was fed with the basal died added with 0.60‰ composite medium-chain fatty acid monoglyceride (glycerol monolaurate 50%+glycerol monodecanoate 50%).

The basal diet adopted the following formulation: alfalfa 24.7%, silage corn 27.6%, corn 24.4%, soybean meal 14.5%, wheat bran 2.0%, cottonseed 4.3%, calcium bicarbonate 0.8%, sodium chloride 0.7% and a premix feed 1% in mass percentage. The nutritional ingredients of the feed raw materials were: crude protein 17.35%, neutral detergent fiber 31.25%, acid detergent fiber 22.63% and crude ash 7.40%.

In the above, the nutritional ingredients of the premix feed were: vitamin A (15,000 IU), vitamin D3 (3000 IU), vitamin E (400 IU), iodine (1 mg), cobalt (0.5 mg), copper (13 mg), iron (90 mg), manganese (60 mg), zinc (100 mg), and selenium (0.5 mg) in 1 kg of the premix feed.

The entire experimental period was divided into two phases, 42 days in total, with 14 days of pre-feeding period, and 28 days of formal experimental period, free water drinking and eating. When the experimental period was ended, milk samples were collected, and milk ingredients were determined using a FOSS Milkoscan FT12 dairy ingredient fast analyzer.

The results of effect of the composite medium-chain fatty acid monoglyceride on the cow milk ingredients are shown in Table 25.

TABLE 25

| | | | Non-Milk Fat |
|---|---|---|---|
| | Milk Fat | Milk Protein | Solid |
| Group | Content % | Content % | Content % |
| Control Group | 3.484 ± 0.308 | 2.784 ± 0.149 | 8.342 ± 0.223 |
| Experimental | 3.544 ± 0.356 | 3.113 ± 0.232** | 8.613 ± 0.151* |
| Group | | | |

It can be seen from the experiment result that adding the composite medium-chain fatty acid monoglyceride may notably improve the protein and non-milk fat solid contents in the cow milk, and notably improve the nutritional quality of the cow milk.

### Example 12

20 healthy Guanling male yellow cattle having similar body weights (275 kg) and being in growing period were selected, and randomly divided into 2 groups, with 10 cattle in each group. The experimental cattle were fed separately in groups. The control group was fed with the basal diet, and the experimental group was fed with the basal diet added with 0.70‰ composite medium-chain fatty acid monoglyceride (glycerol monolaurate 60%+glycerol monodecanoate 40%).

The basal feed formulation: silage napiergrass 60%, corn 24.16%, wheat bran 2.62%, soybean meal 11.72%, soda 0.25%, sodium chloride 0.25%, and a premix feed 1% in mass percentage. The nutritional ingredients of the feed raw materials were: crude protein 13.58%, crude fat 2.98%, neutral detergent fiber 47.78%, acid detergent fiber 19.16%, and crude ash 7.40%.

In the above, the nutritional ingredients of the premix feed were: vitamin A (15,000 IU), vitamin D3 (2000 IU), vitamin E (300 IU), iodine (1 mg), cobalt (1 mg), copper (15 mg), iron (100 mg), manganese (80 mg), zinc (150 mg), and selenium (0.5 mg) in 1 kg of the premix feed.

The entire experimental period was divided into two phases, 44 days in total, with 14 days of pre-feeding period, and 30 days of formal experimental period. During the entire experimental period, the cattle were fed regularly at 6:00 and 16:00, and drank water and ate food freely. Experimental cattle were weighed on an empty stomach before morning feeding on day 1 and the last day of the experimental period, to record the initial experimental weight and end-point weight of each cattle, and calculate the total weight gain and average daily weight gain of each cattle. Average daily weight gain=(initial weight−end-point weight)/number of experimental days.

The results of effect of the composite medium-chain fatty acid monoglyceride on production performance of the Guanling yellow cattle are shown in Table 26.

TABLE 26

| | Initial | | Total | Average Daily |
|---|---|---|---|---|
| | Weight | End-Point | Weight | Weight Gain |
| Group | (kg) | Weight (kg) | Gain (kg) | (g) |
| Control Group | 275.9 ± 25.5 | 286.4 ± 24.0 | 11.0 ± 6.0 | 375.0 ± 141.6 |
| Experimental | 275.5 ± 27.6 | 291.8 ± 29.0 | 16.25 ± 5.7 | 580.4 ± 204.6* |
| Group | | | | |

The experimental results show that after being fed with the composite medium-chain fatty acid monoglyceride for one month, the Guanling yellow cattle in the experimental group are increased in the body weight and the total weight gain by 5.4 kg and 5.25 kg compared with those in the control group, while the average daily weight gain in the experimental group is 1.55 fold (p<0.05) of that of the control group, which means that the composite medium-chain fatty acid monoglyceride may notably improve the production performance of the Guanling yellow cattle.

The examples mentioned above are merely several embodiments of the present disclosure, of which the descriptions are relatively specific and detailed, but they should not be thus construed as limitation on the patent scope of the present disclosure. It should be indicated that a person ordinarily skilled in the art still could make several modifications and improvements without departing from the concept of the present disclosure, all of which fall within the scope of protection of the present disclosure. Therefore, the scope of protection of patent the present disclosure should be determined by the enclosed claims.

What is claimed is:

1. Feed additive, containing glycerol monolaurate and glycerol monodecanoate.

2. The feed additive according to claim 1, wherein a mass ratio of the glycerol monolaurate to the glycerol monodecanoate is 0.11˜9:1.

3. The feed additive according to claim 1, wherein a mass ratio of the glycerol monolaurate to the glycerol monodecanoate is 0.25˜4:1.

4. The feed additive according to claim 1, wherein a mass ratio of the glycerol monolaurate to the glycerol monodecanoate is 0.43˜2.43:1.

5. The feed additive according to claim 1, wherein a mass ratio of the glycerol monolaurate to the glycerol monodecanoate is 0.67˜1.5:1.

6. The feed additive according to claim 1, wherein a mass ratio of the glycerol monolaurate to the glycerol monodecanoate is 1:1.

7. The feed additive according to claim 1, wherein a total amount of the feed additive is 0.1˜2.0‰ of a total mass of an animal feed.

8. The feed additive according to claim 1, further containing an inert carrier, wherein the glycerol monolaurate and/or the glycerol monodecanoate is deposited on the inert carrier.

9. Feed for livestock and poultry or aquatic animal, containing the feed additive according to claim 1.

10. The feed for livestock and poultry or aquatic animal according to claim 9, wherein a total mass of the glycerol monolaurate and the glycerol monodecanoate is 0.1˜2.0‰ of a total mass of the feed for livestock and poultry or aquatic animal.

11. The feed for livestock and poultry or aquatic animal according to claim 9, wherein the feed for livestock and poultry or aquatic animal comprises a broiler feed, a laying hen feed, a pig feed or an aquatic feed, wherein a total mass of the glycerol monolaurate and the glycerol monodecanoate is 0.1˜1.0‰ of a total mass of the feed for livestock and poultry or aquatic animal.

12. The feed for livestock and poultry or aquatic animal according to claim 9, wherein the feed for livestock and poultry or aquatic animal comprises a broiler feed, a laying hen feed, a pig feed or an aquatic feed, wherein a mass ratio of the glycerol monolaurate to the glycerol monodecanoate in the feed additive is 0.11˜9:1.

13. The feed for livestock and poultry or aquatic animal according to claim 9, wherein the feed for livestock and poultry or aquatic animal comprises a broiler feed, wherein a total mass of the glycerol monolaurate and the glycerol monodecanoate is 0.3-0.8‰ of a total mass of the broiler feed; and a mass ratio of the glycerol monolaurate to the glycerol monodecanoate in the feed additive is 1˜3:1, wherein the feed additive improves production performance, chicken yield and meat quality of broilers.

14. The feed for livestock and poultry or aquatic animal according to claim 9, wherein the feed for livestock and poultry or aquatic animal comprises a laying hen feed, wherein a total mass of the glycerol monolaurate and the glycerol monodecanoate is 0.3-0.8‰ of a total mass of the laying hen feed; and a mass ratio of the glycerol monolaurate to the glycerol monodecanoate in the feed additive is 1˜9:1, wherein the feed additive improves laying performance, feed utilization rate and egg quality.

15. The feed for livestock and poultry or aquatic animal according to claim 9, wherein the feed for livestock and poultry or aquatic animal comprises a pig feed, wherein a total mass of the glycerol monolaurate and the glycerol monodecanoate is 0.2-0.8‰ of a total mass of the pig feed; and a mass ratio of the glycerol monolaurate to the glycerol monodecanoate in the feed additive is 1˜9:1, wherein the feed additive improves growth performance, feed utilization rate and pork quality of pigs.

16. The feed for livestock and poultry or aquatic animal according to claim 9, wherein the feed for livestock and poultry or aquatic animal comprises an aquatic feed, wherein the aquatic feed is a grass carp feed, a total mass of the glycerol monolaurate and the glycerol monodecanoate is 0.3‰˜0.8‰ of a total mass of the aquatic feed; and a mass ratio of the glycerol monolaurate to the glycerol monodecanoate in the feed additive is 1˜9:1, wherein the feed additive improves production performance, feed utilization rate and meat quality of aquatic animals.

17. The feed for livestock and poultry or aquatic animal according to claim 9, wherein the feed for livestock and poultry or aquatic animal comprises an aquatic feed, wherein the aquatic feed is a carp feed; a total mass of the glycerol monolaurate and the glycerol monodecanoate is 0.4‰˜0.8‰ of a total mass of the aquatic feed; and a mass ratio of the glycerol monolaurate to the glycerol monodecanoate in the feed additive is 1˜9:1, wherein the feed additive improves production performance, feed utilization rate and meat quality of aquatic animals.

18. The feed for livestock and poultry or aquatic animal according to claim 9, wherein the feed for livestock and poultry or aquatic animal comprises a dairy cow feed or a beef cattle feed, wherein a total mass of the glycerol monolaurate and the glycerol monodecanoate is 0.3‰˜1.5‰ of a total mass of the feed for livestock and poultry or aquatic animal, wherein the feed additive increases contents of proteins and non-milk fat solids in cow milk and improves the production performance and meat quality of beef cattle.

19. The feed for livestock and poultry or aquatic animal according to claim 9, wherein the feed for livestock and poultry or aquatic animal comprises a dairy cow feed or a beef cattle feed, wherein a mass ratio of the glycerol monolaurate to the glycerol monodecanoate in the feed additive is 0.3˜3:1.

20. The feed for livestock and poultry or aquatic animal according to claim 9, wherein the feed for livestock and poultry or aquatic animal comprises a dairy cow feed or a beef cattle feed, wherein a total mass of the glycerol monolaurate and the glycerol monodecanoate is 0.5˜1.2‰ of a total mass of the feed for livestock and poultry or aquatic animal; and a mass ratio of the glycerol monolaurate to the glycerol monodecanoate in the feed additive is 1˜3:1.
